(19) United States
(12) Patent Application Publication
(10) Pub. No.: US 2019/0246834 A1
(43) Pub. Date: Aug. 15, 2019

(54) DUAL-PURPOSE ELECTRIC COOKER

(71) Applicant: Yilma Asfaw, Houston, TX (US)

(72) Inventor: Yilma Asfaw, Houston, TX (US)

(21) Appl. No.: 16/273,155

(22) Filed: Feb. 12, 2019

Related U.S. Application Data
(60) Provisional application No. 62/629,090, filed on Feb. 11, 2018.

(51) Int. Cl. A47J 37/06; A47J 27/00; A47J 36/02; A21D 13/43

(52) U.S. Cl. CPC A47J 37/0611; A21D 13/43; A47J 36/025; A47J 27/004

(57) ABSTRACT

The invention is a dual-purpose electric bread cooker having two baking plates, a lid, a base, thermostat control knobs, light indicators and legs. The base on the electric bread cooker having a cylindrical shaped baking pan for baking Himbasha (also known as Ambasha) bread and a top plate pivotally mounted on to the base plate, the top plate covers the bottom baking plate when baking Himbasha. A first embodiment shows the top plate can be opened about 180 degrees from the surface of the bottom plate to be used to bake Injera (Ethiopian flatbread). A second embodiment of flip-able lid can used when cooking space is small. The top and the bottom baking plates may be connected to heating source. One temperature control knob controls the temperature of the bottom baking plate and another thermostat knob controls the temperature of the top baking plate. The electric cooker has a handle to open and close the lid, the inside of the top lid is a baking plate. The cooker also has additional lid to be used to cover the top baking plate when baking Injera break. The electric cooker also has bread stamp set with different stamp shapes that can be used to make different shapes on the top surface of Himbasha bread.

### BACKGROUND OF THE INVENTION

The present invention relates generally to the field of cooking equipment and specifically to Ethiopian bread such as Himbasha (also known as Ambasha) and Injera. The cooker also has bread stamps to imprint certain shapes on the top surface of Himbasha bread. The same cooker can be used to bake Difo Dabo, Mulmul Dabo and other types of Ethiopian traditional breads, none traditional breads and other flatbreads such as chapati, Indian naan, crepe, Chinese flatbread etc. The electric cooker can also be used to cook pasta cake, tibse, wote, pasta al forno, lasagna, pizza etc. Research on different patent databases shows that no previous filed patent application found that focuses on Himbasha cooker.

### SUMMARY OF THE INVENTION

The present invention relates to electrical cooker for baking Ethiopian flatbread, the cooker comprises a bottom baking plate having a cylindrical shape and a top baking plate serve as a lid for the bottom baking plate when baking Himbasha and the same top baking plate can be used to bake Injera as well. The top baking plate used to bake Injera, a separate lid can be used to cover the Injera batter when baking commences. Both the top and bottom baking plates can be removed from the electric cooker for cleaning. Himbasha is a thick flatbread widely known in Ethiopia and Eritrea. The baking processes of Himbasha is not that easy so that limited Himbasha making mainly in the Northern part of Ethiopia and Eritrea. Himbasha bread has grooves on the top surface, the grooves mainly done by spoon, knife and/or fork. The grooving process takes long time and need special art skill. That is believed to limit the baking of Himbasha only in certain part of Ethiopia and Himbasha baking among Ethiopian in diaspora is not common as well because of the time-consuming nature of the preparation and baking processes. The present invention will make Himbasha baking easy and fun by providing especial electric cooker and bread stamps that anybody without any special art skill can now bake Himbasha bread. The same cooker can be used to bake Difo abo, Mulmul and other types of Ethiopian traditional, none traditional breads and other flatbreads such as chapati, Indian naan, crepe, Chinese flatbread etc. The cooker can also be used to cook pasta cake, tibse, wote, pasta al forno, lasagna, pizza. Research on different patent databases shows that no previous filed patent application found that focuses on Himbasha cooker.

A top baking plate is pivotally mounted on to the base plate, and both plates (top and base baking plates) have heating sources at the back of the plates. The heating element may be shaped in any desired manner for uniform distribution of heat on top and bottom baking plate surfaces. Heating can be provided in the form of resistive or infra-red heating elements or open heat source heat such as charcoal, wood or other heat source.

An object of the present invention is thus to provide an electric cooker for baking Himbasha bread with relatively low effort and the same cooker can be used to bake Injera, Difo dabo, Mulmul dabo and other types of Ethiopian traditional, none traditional breads and other flatbreads such as chapati, Indian naan, crepe, Chinese flatbread etc. The cooker can also be used to cook pasta cake, tibse, wote, pasta al forno, lasagna, pizza. Another object of the present invention is to provide an electric cooker with stamps, the stamps helps to quickly imprint traditional shapes on the Hambasha surface. Currently, people have to manually make the shapes using knife, fork and spoons, which is very time consuming and the final shapes are in most cases crooked. The invented cooker is energy efficient, compact and dual-purpose cooker that mean the same cooker can be used to bake both Himbasha and Injera.

Reference should be made to the accompanying drawings and description of the present invention for a better understanding of the present invention and its advantages.

### SHORT DESCRIPTION OF THE DRAWINGS

FIG. 1 is a front perspective view of the present invention having its top baking plate (or lid) in closed position;

FIG. 2 is a front view of the present invention having its top baking plate (or lid) in closed position;

FIG. 3 is a top view of the present invention having its top baking plate (or lid) in closed position;

FIG. 4 is a side view of the present invention having its top baking plate (or lid) in closed position;

FIG. 5 is a side view of the present invention having its top baking plate (or lid) in opened position;

FIG. 6 is a perspective view of the present invention having its top baking plate in opened position showing the Himbasha baking plate and a separate lid covering the Injera baking plate;

FIG. 7 is a perspective view of the present invention having its top baking plate in opened position showing the Himbasha on bottom baking plate and Injera on top baking plate;

FIG. 8 is a perspective bottom view of the present invention showing bread stamp sets without handles;

FIG. 9 is a perspective top view of the present invention showing bread stamp sets with handles;

FIG. 10 is a perspective view of the present invention showing an arc shaped bread stamp creating grooves;

FIG. 11 is a side view of the present invention having a second embodiment for the lid which is flip-able to bake Injera;

### DESCRIPTION OF THE PRESENT INVENTION

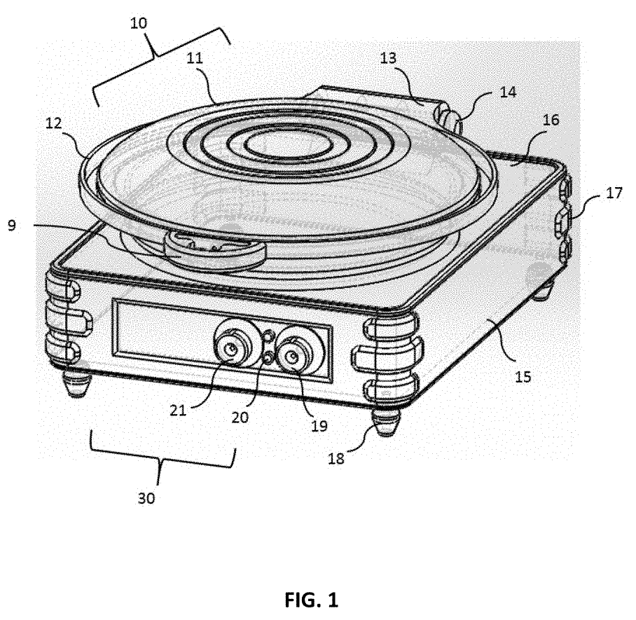

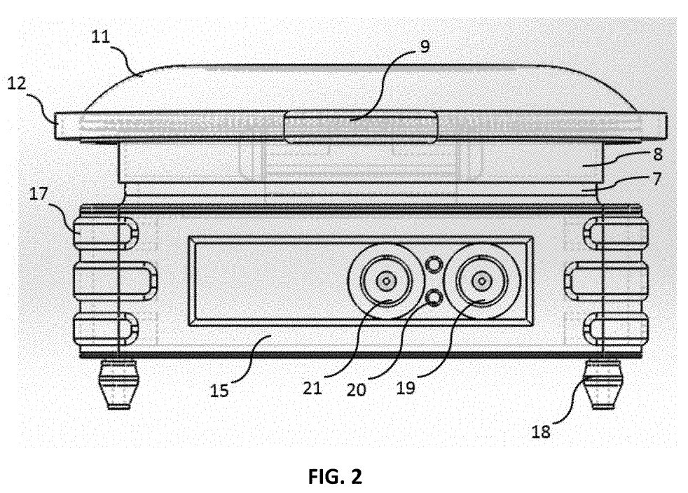

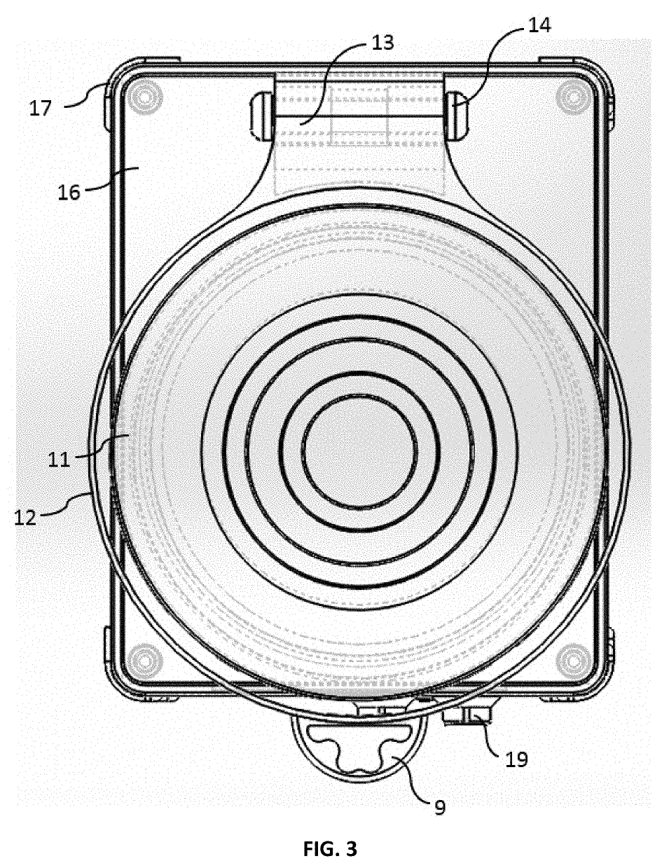

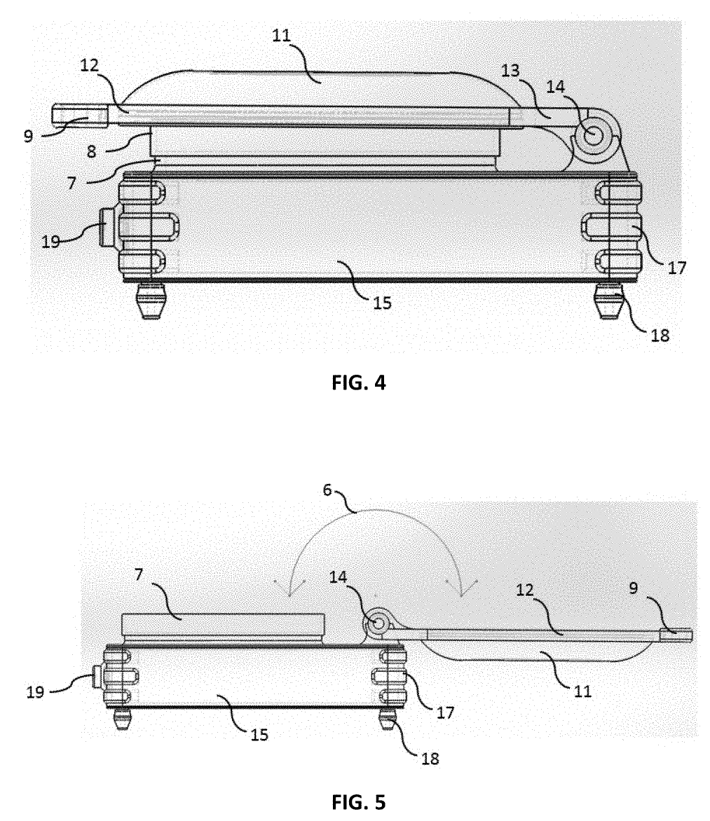

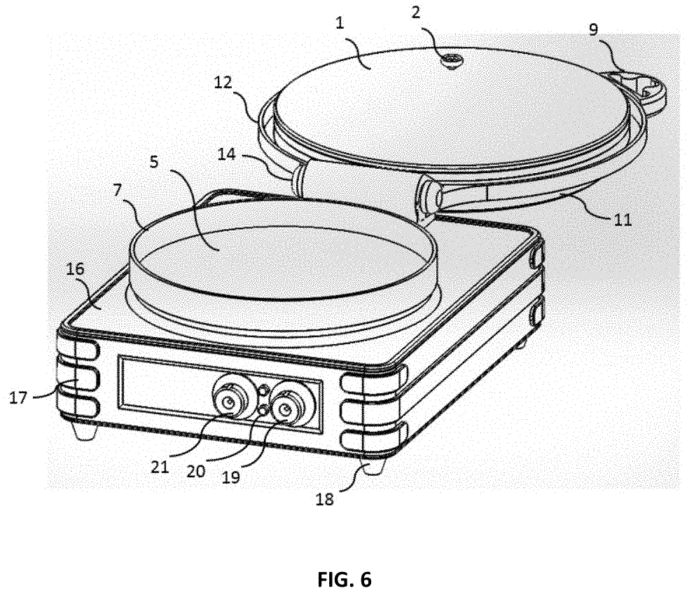

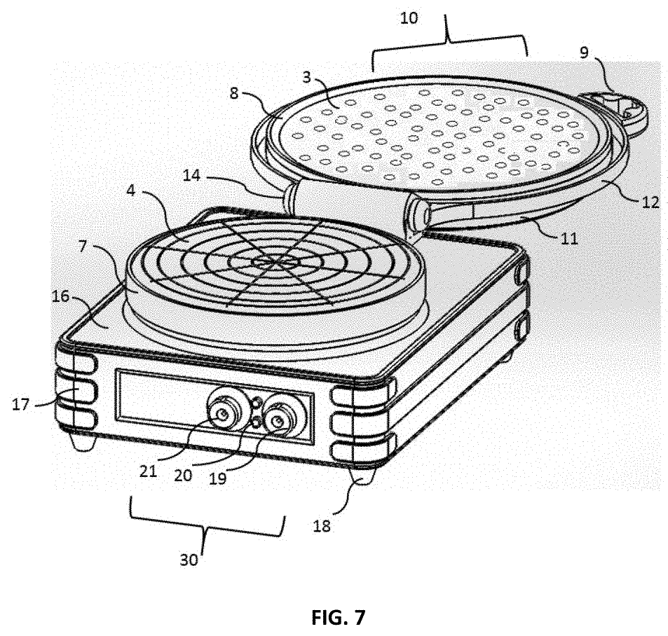

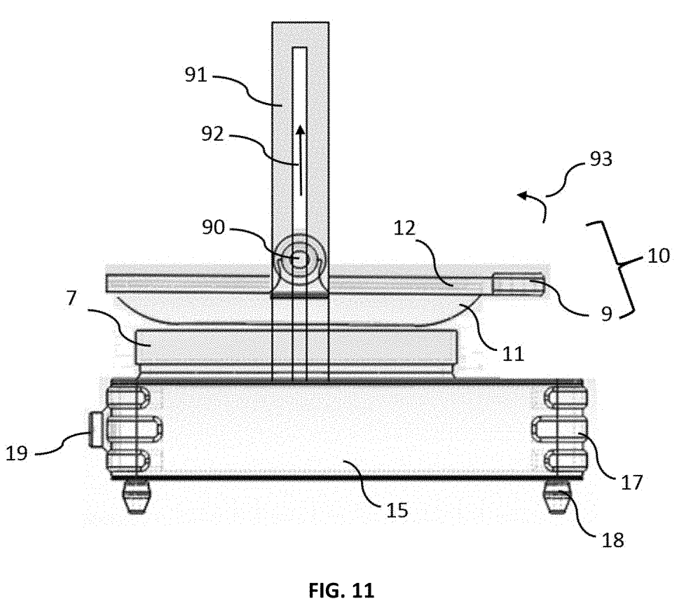

The present invention comprises of two baking plates 8,7 as shown on FIG. 2, FIG. 4, FIG. 5, FIG. 6, FIG. 7, FIG. 11, base 30, base cover 16, legs 18, separate lid 10, handle 9. FIG. 1, FIG. 2, FIG. 3 and FIG. 4 show the electric cooker with lid 10 in closed position, the lid 10 is hinged 13 to the base cover 16, a pin 14 slide through a hole for connection of the lid 10 with the base cover 16; the lid 10 consists of a dome shaped outer cover 11 on the back which is connected to a ring-shaped support bar 12, a handle 9 connected with the ring-shaped support bar 12; the inner side of the lid 10 has baking plate 8 which has flat baking surface and the surface curved up at the periphery. The base unit 30 consists of the base cover 15, scratch protectors 17 on the edges, legs 18 to keep the electric cooker away from the surface on which it seats; a thermostat knob 19 controls the temperature of the bottom baking plate 7, a second thermostat knob 21 controls the temperature of the top baking plate 8; the top light 20 turns on when heater on the top plate 8 turned on and the bottom light 20 turns on when the heater on bottom plate 7 turned on. Both the top plate 8 and bottom plate 7 can be removed from the electric cooker for washing.

FIG. 5 shows lid 10 in open 6 position so that the top baking plate 12 faces up and levels to bake Injera 3 (FIG. 7) on the baking pan 8. FIG. 6 shows the top baking plate 8 is covered by separate lid 1 when Injera 3 baking commences in this case bottom baking plate 7 does not need to be working; however; for Himbasha baking, the dough pours into a cylindrical bottom baking plate 7 which can have nonstick coated surface 5, the top plate 8 serve as a lid 10 for the bottom plate 7, in this case both bottom plate 7 and top baking plate 8 need to have heaters turned on. FIG. 7 shows Himbasha bread 4 on bottom baking plate 7 and Injera 3 on top baking plate 8 and the external lid 1 has handle 2.

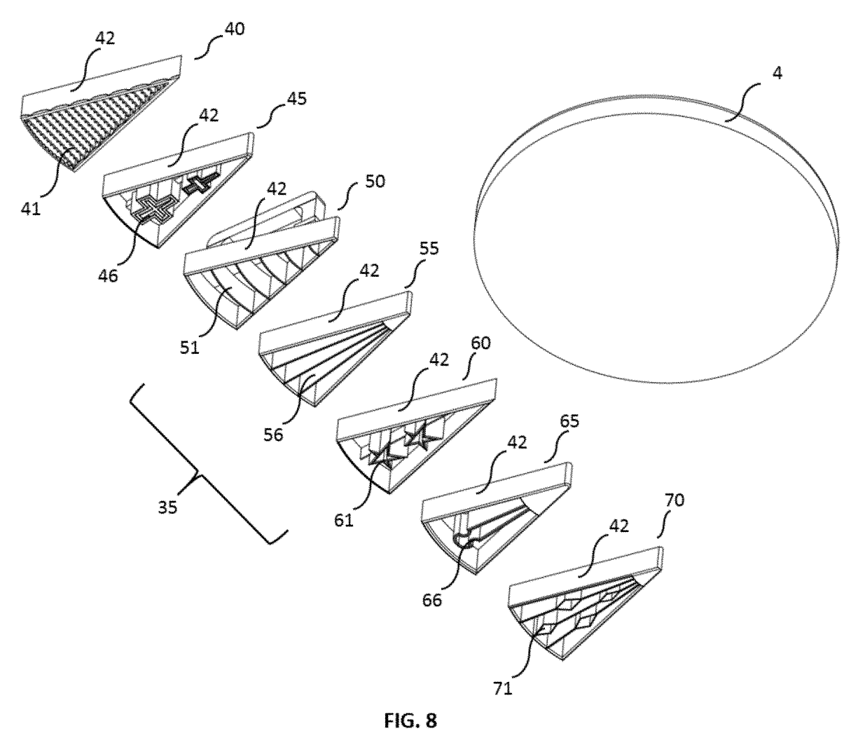

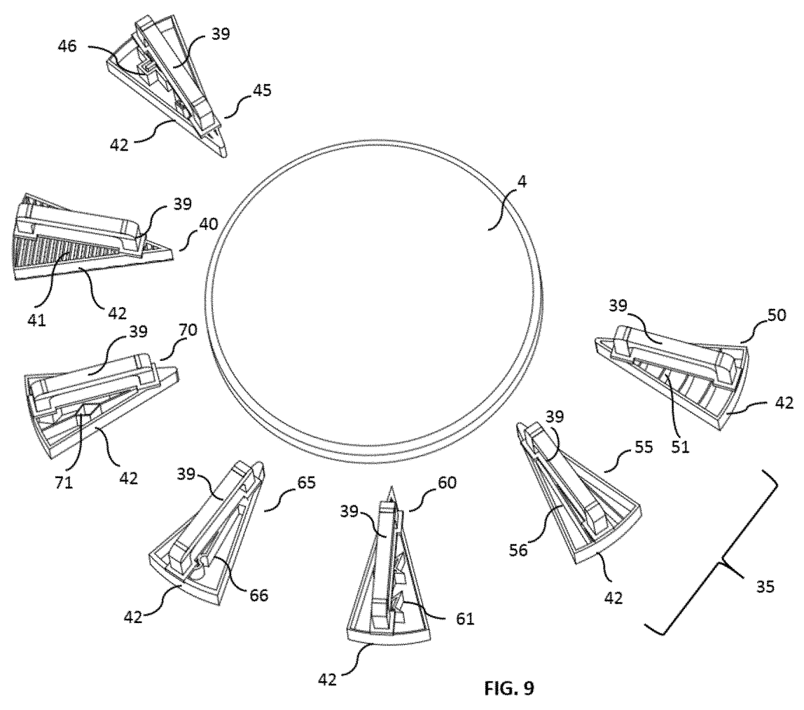

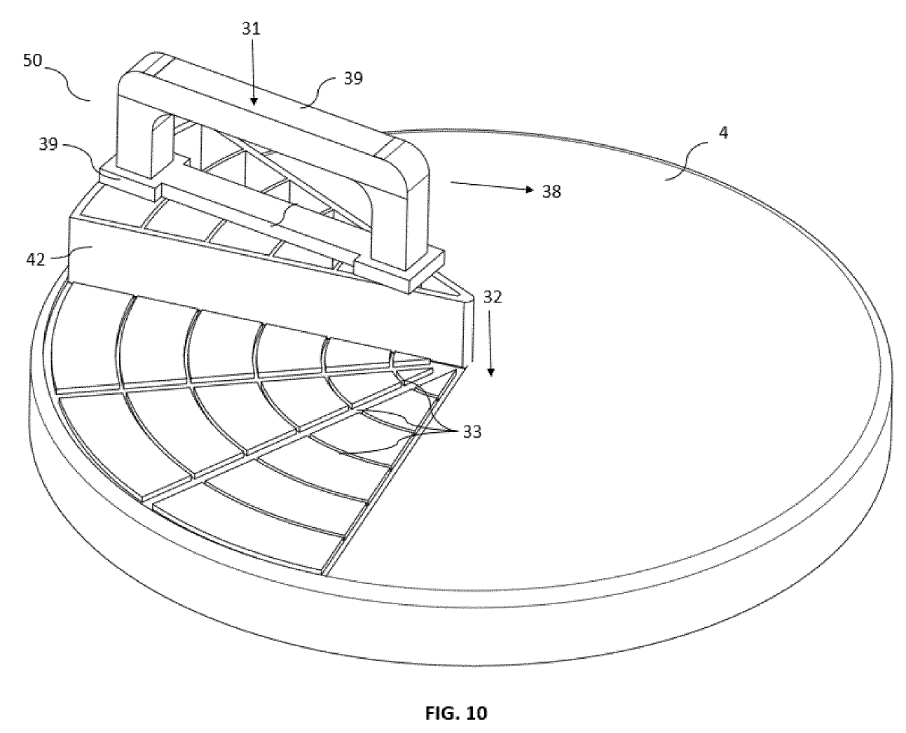

FIG. 8 and FIG. 9 show bread stamp set 35 which comprises crescent (ice cube) shaped bread stamp 40, cross (Lalibela) shaped bread stamp 45, arc (can also be made straight instead of arc shapes) shaped bread stamp 50, radian shaped bread stamp 55, star shaped bread stamp 60, Axum shaped bread stamp 65, diamond shaped bread stamp 70, another shape stamps can also be added. All of the stamps 40, 45,50,55,60,65, 70 have handles 39 and sector shaped frames 42; the crescent (ice cube) shaped bread stamp 40 has saw shaped bars 41, the cross (Lalibela) shaped bread stamp 45 has a cross shaped bars 46, the arc shaped bread stamp 50 has arc shaped bars 51, the radian shaped bread stamp 55 has straight bars 56 in a radiant arrangement, the star shaped bread stamp 60 has star shaped bars 61, the Axum shaped bread stamp 65 has bar in Axum shape 66, the diamond shaped bread stamp 70 has diamond shaped bars 71. FIG. 10 shows the arc shaped bread stamp 50 creating grooves 33 on the Himbasha 4 bread surface; in the process of baking Hambasha bread 4, first dough need to be poured on the bottom baking plate 7 and make the dough flat using hand then rub food oil on the surface of the Himbasha dough, put the stamp 50 on the dough surface, align the sector 42 edge close to the center, slowly press down the bread stamp 50 to create grooves 33, then move the stamp 50 in a clockwise 38 or anti-clockwise direction until making the grooves 33 on all parts of the dough surface 4. Multiple stamps may be used when creating grooves on Hambasha surface. Even though only 7 bread stamps are shown in the present invention, modification and alteration of shapes might be done for the final bread stamp manufacturing. In the present invention, the bread stamps 40,45,50,55,60,65, 70 has a single sector design, in the manufacturing two or more bread stamps might be joined side by side so that groove making or stamping will take less time.

FIG. 11 shows an alternative embodiment for the lid 10 connection with the base 30 where the lid 30 can be flipped 93 upside-down instead of the lid 10 opens about 180 degrees hinged 13,14 to the base cover 16 as shown in FIG. 5, FIG. 6, FIG. 7. when lid 10 flipped 93 upside-down, the top baking plate 8 faces upward. To flip 93 the lid 10 upside-down, the lid 10 can be moved upward 92 by sliding the lid 10 which has pines 90 passed through metal rails 91 attached to the base 15, rotates 93 the lid 10 about 180 degrees until it is upside-down then moves the lid 10 back to the original position to rest the lid 10 on top of the baking plate 7. The second embodiment design is compact and is very useful especially these days many Ethiopian people started living in condominium apartments which are normally small in sizes so cooker that takes smaller space like the second embodiment FIG. 11 is a preference to fit in the available spaces.

While specific embodiments of the invention have been shown and described in detail to illustrate the application of the principles of the invention, it will be understood that the invention may be altered or modified without departing from such principles.

1. A dual-purpose electric cooker for baking Ethiopian traditional bread comprising:
Two baking plates, external lid, thermostats, light indicators, base and bread stamp sets; the bottom baking plate uses for baking Himbasha bread (also known as Ambasha) and the top baking plate uses for baking Injera, the top plate also uses as a cover for the bottom plate when baking Himbasha, one thermostat knob controls the temperature of bottom baking plate and the second thermostat knob controls the temperature of the top baking plate, the top light indicator turns on when heater on top plate turned on and the bottom light indication indicates when heater on the bottom turned on. The same cooker can be used to bake Difo Dabo, Mulmul Dabo and other types of Ethiopian traditional breads, none traditional breads and other flatbreads such as chapati, Indian naan, crepe, Chinese flatbread etc. The cooker can also be used to cook tibse, wote, pasta al forno, lasagna, pizza, pasta cake etc.

2. A bread stamp set for making grooves or dent on the surface the Himbasha dough:
All the seven bread stamps have handles and sector shaped frames and different shape bars for creating different shapes

3. The dual-purpose electric cooker according to claim 1, wherein the bottom plate has cylindrical shape and may be coated with nonstick

4. The dual-purpose electric cooker according to claim 1, wherein the top plate has flat surface which is curved up on the periphery and it may be coated with nonstick coating

5. The dual-purpose electric cooker according to claim 1, wherein the top plate is a dual purpose which serves as cover for the bottom plate when baking Himbasha bread and the same plate serves as baking pan for baking Injera

6. The dual-purpose electric cooker according to claim 1, wherein the base has base cover, lid, two thermostats to control the two baking plates, two light indicators, legs and scratch protector

7. The bread stamp set according to claim 2, wherein one of the stamps is crescent (ice cube) shaped bread stamp which has seesaw shaped bars

8. The bread stamp set according to claim 2, wherein one of the stamps is cross (Lalibela) shaped bread stamp which has bars in cross shape

9. The bread stamp set according to claim 2, wherein one of the stamps is arc or straight shaped bread stamp which has bars in arc (or straight) shaped

10. The bread stamp set according to claim 2, wherein one of the stamps is radian shaped bread stamp which has bars in radiant arrangement

11. The bread stamp set according to claim 2, wherein one of the stamps is star shaped bread stamp which has star shaped bars

12. The bread stamp set according to claim 2, wherein one of the stamps is Axum shaped bread stamp which has bar in Axum shape

13. The bread stamp set according to claim 2, wherein one of the stamps is diamond shaped bread stamp which has bars in diamond shape

14. The dual-purpose electric cooker according to claim 1, wherein an alternative flip-able top lid design where the top lid can be flipped over to bake Injera. The flip-able design is a compact design the fits in small baking places
